(19) United States
(12) Patent Application Publication
(10) Pub. No.: US 2024/0372914 A1
(43) Pub. Date: Nov. 7, 2024

(54) Method and system of video conferencing with stream forwarding

(71) Applicant: Suparna Sen, Cupertino, CA (US)

(72) Inventor: Suparna Sen, Cupertino, CA (US)

(21) Appl. No.: 18/310,546

(22) Filed: May 2, 2023

(51) Int. Cl. H04L 67/1061; H04L 65/403; H04L 67/104

(52) U.S. Cl. CPC H04L 67/1061; H04L 65/403; H04L 67/1046

(57) ABSTRACT

A method and system for conducting a multi-party video conference using peer-to-peer connections made by a web browser on each computer is described. The system includes a server that helps pairs of web browsers to establish a communication channel between each other. The server does not carry any media (i.e. audio or video) streams. Connections between users in the video conference form a graph, where each node need not be connected to every other node. Nodes forward streams received from other nodes to some other nodes such that all nodes end up receiving streams from all other nodes after one or more hops. Nodes forward streams only for the video conference they are part of and there are no super nodes.

### TECHNICAL FIELD

The present invention relates to video teleconferencing systems that may have many users. In particular, it implements an architecture where media streams from users do not need a central server to reach other users.

### BACKGROUND

### Video Conferencing

Video conferencing enables users located at two or more sites to simultaneously interact via two-way video and audio transmissions. In addition, modern video conferencing systems allow participants to share their screen, which may display text, image or even play a video.

### Server Based Video Conferencing

Most video conferencing systems use a server as a mechanism to send audio and video streams to individual users. Each user sends its audio and video streams to the server and receives from it the audio and video streams of other users. (See FIG. 1). The benefit to the users is that they need to maintain only one communication channel, which is to the server. The downside is that the video conferencing provider must incur the cost of maintaining the server and the network cost of sending and receiving media streams. This cost is then passed to the users.

### Peer-to-Peer Video Conferencing

Some peer-to-peer video conferencing systems avoid using a server. (See FIG. 2) In such systems, each user connects to every other user. However, such systems find it difficult to scale beyond a small number of users as the number of connections needed for each user grows rapidly at O(N) and it is hard to maintain so many connections.

### Hybrid Systems Sing Super Nodes

Some peer-to-peer video conferencing systems e.g. Skype in its earlier version, used some of its users as “super nodes”, which forwarded the media streams of many users from many video conferences. Each super node could forward streams of hundreds of users and thus acted like a server in server based video conferences. Skype moved away from such an architecture when some of its overloaded super nodes crashed and disrupted a lot of video conferences.

### SUMMARY

The present invention is a modified peer-to-peer video conferencing system which limits the number of connections from each user to a small number M i.e. it is an O(1) system. M is typically 3 (See FIG. 3) or 2 (See Fig.) but may even be 1 (See FIG. 5). Connections between users in the video conference form a graph, where each node need not be connected to every other node. Nodes forward streams received from other nodes to some other nodes such that all nodes end up receiving streams from all other nodes after one or more hops. Nodes forward streams only for the video conference they are part of and there are no super nodes.

### BRIEF DESCRIPTION OF THE DRAWINGS

FIG. 1 shows the architecture of a server based video conferencing system, where each user is connected only to a server and sends its audio and video streams to the server to route them to other users.

FIG. 2 shows the architecture of a peer-to-peer video conferencing system, where each user is connected to all users and sends its audio and video streams to all other users. Each user has O(N) connections.

FIG. 3 shows the architecture of a system described in this application, which is a peer-to-peer video conferencing system that uses stream forwarding to limit the number of connections for a user to a constant, here 3. Each user has O(1) connections.

FIG. 4 shows another example of a system described in this application. Here the maximum number of connections for a user is 2.

FIG. 5 shows another example of a system described in this application. Here the maximum number of connections for a user is only 1.

FIG. 6 shows the steps in a new user's joining a video conference.

FIG. 7 shows the steps in a user sending a media stream to another user.

### DETAILED DESCRIPTION

### Definitions

As used in this description and the accompanying claims, the following terms shall have the meanings indicated, unless the context requires otherwise.

“Media stream” is the continuous flow of audio and/or video content over some communication medium, usually the internet. The audio/video content can come from a live camera or some pre-existing image, video or digital document.

“Video Conferencing”, sometimes also called “teleconferencing”, is the exchange of media streams between a plurality of participants through a communication network. Typically, a provider of a video conferencing system supports multiple such conferences running concurrently, each with its set of participants.

“Participant” refers to a person or a device used by a person for participating in a video conference.

“User” is a synonym of a participant.

“Node” is another synonym of a participant, used when participants are organized as a node graph.

“Node graph” is a data structure made up of vertices (same as nodes here) which are connected by edges, where edges are connections between nodes. In the method and system described in this patent application,
The node graph also has information on which streams to send and receive on the edges. E.g. with respect to FIG. 4, the node graph indicates that User 2:
   has edges to Users 1 and 3.
   sends streams:
      i. of User 1 and 2 (itself) to User 3
      ii. of Users 2 and 3 to User 1.
   receives streams:
      i. of User 1 and 5 from User 1
      ii. of User 3 and 4 from User 3.
There is a different node graph corresponding to each combination of the number of participants N and the max fanout per node M.
Node graphs for any <N,M> can be computed as needed but for efficiency they can also be pre-computed and stored in the server.

“Fanout” is the maximum number of connections from a node. The method and system described in this patent application solves the scalability problem of peer-to-peer architecture by limiting the fanout of nodes using forwarding of streams.

“Forwarding” of a media stream is the sending of a media stream that did not originate from the local user A but was received by it from another user B, to another user C.

“Server” is a device, usually a computer, that is deployed by the provider of a Video Conferencing system. Typically, a provider deploys multiple such devices and each device is called a server instance. Each video conference is usually associated with a single server instance, though one server instance may support multiple such conferences concurrently. Multiple server instances can support a lot of video conferences concurrently.

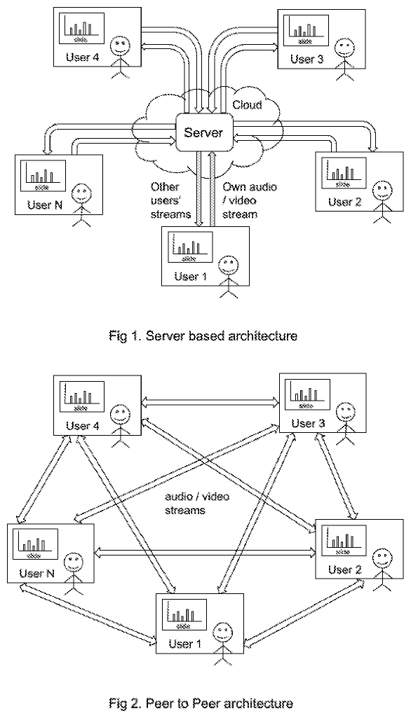

“Server-based” video conferencing system usually means an architecture where each user needs to connect only with a server, sends its media streams only to that server and receives media streams of other users from that server. FIG. 1 illustrates such an architecture.

“Peer-to-peer” video conferencing system usually means an architecture where each user connects to every other user, sends each of them its media streams and receives from each of them their media streams. FIG. 2 illustrates such an architecture.

### Current Video Conferencing Architectures

The two commonly used architectures in Video Conferencing systems are server-based and peer-to-peer as defined above and also in the background section earlier. Each has its own downside.
The server based architecture is simpler but more expensive as the provider must incur the cost of maintaining the server and the network cost of sending and receiving media streams. This cost is then passed to the users.
The peer-to-peer architecture is cheaper but is difficult to scale beyond a small number of users as the number of connections needed for each user grows rapidly at O(N) and it is hard to maintain so many connections.
   New Architecture in this Patent Application

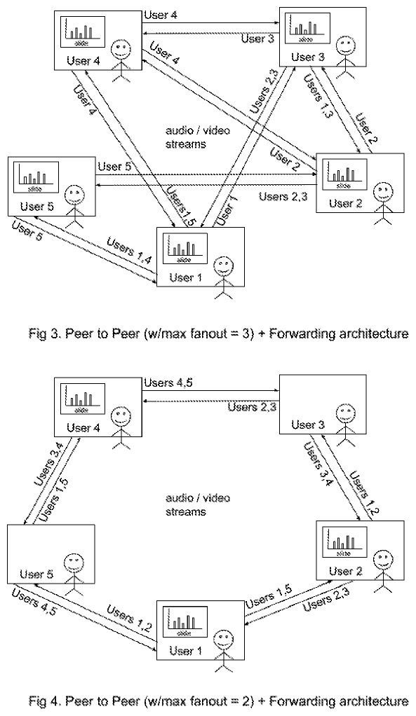

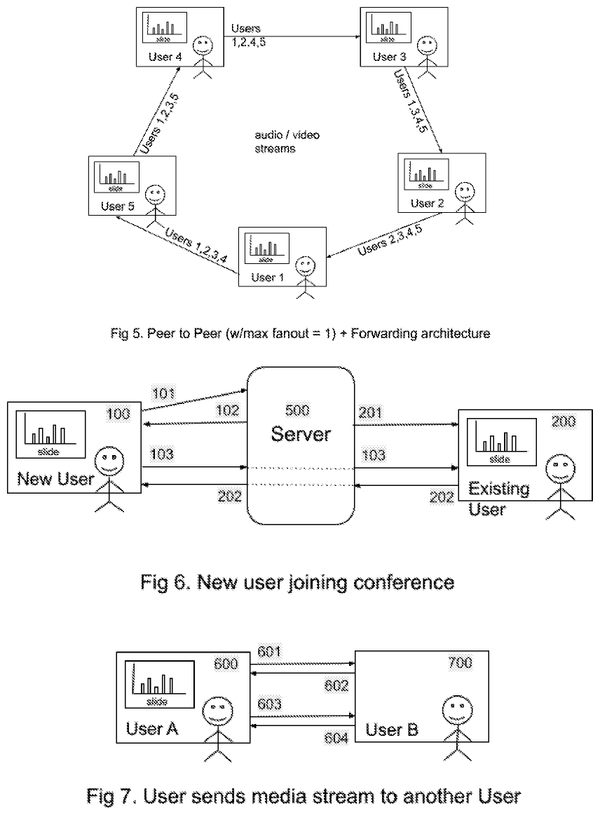

The method and system described in this application overcomes both downsides described above. It uses a peer-to-peer architecture to avoid the cost of a server, while solving its scalability problem by limiting the number of connections of any user to O(1). It manages to do this by organizing the users in a node graph where each node need not be connected to every other node. Nodes forward streams received from other nodes to some other nodes such that all nodes end up receiving streams from all other nodes after one or more hops. FIGS. 3, 4 and 5 illustrate this architecture.

FIG. 4 is a good example to explain this architecture in more detail. There are 5 users in this video conference. Some of the users may have some documents or presentations or videos to share. These are represented as “slide” in the figure and are sent to other users as media streams. So, each user must receive media streams from 4 other users. They receive those 4 sets of streams over only 2 connections each.
User 1: is connected only to Users 2 and 5. In a usual peer-to-peer architecture, it would receive the media streams of those users only with these connections. In our modified architecture, it receives User 3's streams from User 2 and User 4's streams from User 5 as well. Thus, it receives streams of the 4 remote users from only two connections. It also sends streams for User 1 (itself) and 5 to User 2 and streams for Users 1 and 2 to User 5.
User 2: is connected only to users 1 and 3. It receives streams of User 1 and 5 from User 1 and streams of User 3 and 4 from User 3. It also sends streams for User 1 and 2 (itself) to User 3 and streams for Users 2 and 3 to User 1.
User 3: is connected only to users 2 and 4. It receives streams of User 1 and 2 from User 2 and streams of User 4 and 5 from User 4. It also sends streams for User 2 and 3 (itself) to User 4 and streams for Users 3 and 4 to User 2.
User 4: is connected only to users 3 and 5. It receives streams of User 2 and 3 from User 3 and streams of User 1 and 5 from User 5. It also sends streams for User 3 and 4 (itself) to User 5 and streams for Users 4 and 5 to User 3.
User 5: is connected only to users 1 and 4. It receives streams of User 1 and 2 from User 1 and streams of User 3 and 4 from User 4. It also sends streams for User 4 and 5 (itself) to User 1 and streams for Users 1 and 5 to User 4.

### Server Used for Control Operations

The method and system described in this application does use a server but only for control operations and not for transmitting any audio or video streams. Hence the server's cpu and network bandwidth requirement is quite low. It is used only during setting up the connections between users and the forwarding scheme for streams at the beginning of the video conference. FIG. 6 describes the algorithm of that setup. Details are explained below.
A new user 100 joins the conference by connecting to the server and sending it a join message 101.
The server 500 sends a reply 102 with:
   a user number for that user. All subsequent communications with that user use that user number as its id.
   If this is not the first user, the server also returns the node graph for the updated conference, which now includes the new user.
When the first user joins the conference, the server creates a data structure, called “room” for it. This data structure holds control information necessary for managing the conference, including any locks or queues. For all subsequent users joining the conference, the server broadcasts a message 201 to all other users 200 already in the conference. Message 201 has the id of the new user and the updated node graph reflecting the addition of the new user as a node.
The node graph has information on which users need to connect to which other users and which streams to forward to them. E.g. with respect to FIG. 4, the node graph indicates that User 2 must:
   connect to Users 1 and 3
   send streams for User 1 and 2 (itself) to User 3 and streams for Users 2 and 3 to User 1.
   receive streams of User 1 and 5 from User 1 and streams of User 3 and 4 from User 3.
The new user 100 must connect to the users prescribed in the node graph.
Existing users 200 may have been connected to some users as prescribed by a Node graph<N, M>. When they receive the new node graph <N+1, M> in message 201, they may need to disconnect from some existing users and connect to some other users as prescribed by the new node graph.
A user typically does not know the connection address of the other user that it needs to connect to. The only connection address that is known beforehand is that of the server, which is available in the code running in each user's device. As all users connect to the server, the server can forward control messages, including these connect messages from one user to another. Hence, the server helps two users connect to each other by passing messages, necessary to establish connections. We give an example below of such a flow of messages using the webrtc protocol.
New user 100 sends a connection offer 103 to the server, which passes it on to existing user 200. This offer includes the connection address of new user 100.
The existing user 200 accepts the offer by sending an answer 202 to the server, which passes it on to the new user 100. This answer includes the connection address of existing user 200.
The exchange of offer and answer messages between new user 100 and existing user 200 enables them to establish a connection between them.
   User Communication without Using Server

Once two users establish a connection between each other, the server is no longer needed for exchanging any messages between them. Any additional control messages and the media streams now flow over the connection between the users.

FIG. 7 describes a flow of messages needed to send a media stream from one user to another. An example of a control message is the metadata, including a stream id and the associated user id, of any upcoming stream to be sent by a user to another user. As the receiving user may receive streams of multiple users from the sending user, the control message helps it understand which stream corresponds to which user. Details of the steps are explained below.
User A 600 sends a message 601 to another user B 700. This message has the metadata, including a stream id and the associated user id, of a media stream to be sent by user A. The user id may be of another user C, whose media stream is being forwarded by user A to user B.
User B 700 stores that metadata in its internal data structure and replies with an acknowledgment message 602.
Upon receiving this ack, user A 600 adds the media stream 603 to the connection with user B 700.
User B 700 receives the media stream in its connection with user A 600 but knows that this media stream is from user C and displays it in its layout of the video conference in the tile for user C. After that, User B 700 replies with message 604.

It is intended that the scope of this disclosure be defined by the following claims and their equivalents:

1. A method for video conferencing between multiple users on devices with a camera and microphone, that uses a server only for control operations and not for transmitting any audio or video streams, comprising the server:
helping users organize as nodes in a graph;
helping establish peer-to-peer communication channels between nodes;
instructing nodes on which streams received from some nodes to forward to some other nodes.

2. A method of claim 1, further comprising the server,
helping nodes adjust to a new graph when a node joins or leaves a conference;
helping nodes order their interactions with other nodes by managing locks.

3. A method for video conferencing between multiple users, organized as nodes in a graph where nodes may forward audio and video streams received from some nodes to other nodes, comprising:
connecting each node only to a maximum of M nodes, where M is a constant that is less than or equal to the total number of users N in the video conference;
each node sending audio and video streams from the local user as well as streams received from some remote users to some of the other remote users;
all nodes receiving streams from all other nodes either directly or via forwarding over one or more nodes;
nodes forwarding streams only for the video conference they are part of.

4. The method of claim 3, further comprising:
there are no super nodes that forward streams of nodes from multiple conferences;
thus crashing of a node does not impact more than one video conference.

5. The method of claim 3, further comprising,
sharing a browser tab or window or the whole device screen, including any image or video playing in it, with other users by sending their audio and/or video streams along with the audio and video streams from the local camera and mic.

6. A method for video conferencing between multiple users that reduces the bandwidth needed for outgoing local video stream, comprising
reducing the frame rate of the outgoing video stream when the local user is not speaking;
sending the display size of a remote user's video in the device, based on the layout in effect, to the remote user;
adjusting the video resolution of the outgoing video stream of the local user based on the display size of that video on the receiving user's device.
